(19) United States
(12) Patent Application Publication
(10) Pub. No.: US 2016/0214906 A1
(43) Pub. Date: Jul. 28, 2016

(54) METHOD FOR PRODUCING CEMENT WITH AN INTEGRATED CURING AGENT INCLUDED THEREIN AND THE USE THEREOF IN CEMENT-BASED MATERIALS AND THE CEMENT PRODUCED

(71) Applicant: CEMEX RESEARCH GROUP AG., Brugg bei Biel (CH)

(72) Inventors: Homero RAMIREZ TOVIAS, Monterrey N.L (MX); Karla SERRANO GONZALEZ, Monterrey N.L (MX); Nestor Isaias QUINTERO MORA, Biel Bern (CH)

(73) Assignee: CEMEX RESEARCH GROUP AG, Bruegg bel Biel (CH)

(21) Appl. No.: 14/914,198

(22) PCT Filed: Aug. 28, 2014
(86) PCT No.: PCT/EP2014/068249

§ 371 Date: Feb. 24, 2016

(30) Foreign Application Priority Data
Sep. 2, 2013 (MX) MX/A/2013/010088

(51) Int. Cl. C04B 40/00; C04B 24/38

(52) U.S. Cl. CPC C04B 40/0028; C04B 24/383; C04B 2111/346

(57) ABSTRACT

A method to produce a cement with an integrated curing agent for concrete mixtures, mortars and other cement-based materials is disclosed. The method describes an integrated milling of all cement components (clinker, gypsum and other additives) and the curing agent, that will allow reducing the plastic shrinkage cracking on the casted elements that use this cement-based mix.

### FIELD OF THE INVENTION

The present invention is related to the production of a cement with an integrated curing agent that will allow an enhanced curing process and the reduction of plastic shrinkage cracking of concrete and mortar mixes produced by the natural or accelerated moisture loss in the surface of concrete and mortars.

### BACKGROUND OF THE INVENTION

Concrete is by far the most frequently used construction material in the world. It is used in all kinds of climates, places, and applications, which means it is required to have specific behaviour properties, in order to keep structures and elements in good shape in such environments. One of the main uses of concrete is in elements with a large surface exposed to environmental conditions, for example road paving, parking lots, road surfaces, apartments, floor slabs, irrigation canals and general construction.

These large surface concrete elements exposed to environmental conditions that combine high temperatures, low moisture and wind tend to lose moisture quickly. This produces a change in the volume of the concrete mass, which produces local plastic shrinkage that causes fissures or cracks to happen, known as plastic shrinkage cracking.

These mechanisms take place when the concrete is still fresh and has not yet developed enough strength to support stress caused by the plastic shrinkage due to the moisture loss effect. In order to avoid this loss of moisture from the surface of concrete or mortar mixes, it is necessary to assure the correct curing process and to take the precautionary measures to minimise the effects of environmental conditions.

The cement hydration process requires a certain water content for the chemical reactions to take place and to avoid plastic cracking, thus water retention is essential in this process. A mix design with the right water content will result in a concrete or mortar with a well-developed compressive strength, as well as satisfactory durability behaviour. When less water than the required content is added or there is loss of moisture, the opposite behaviour takes place.

In practice, measures are taken to avoid the concrete or mortar surfaces to dry off too quickly, so that the development of shrinkage cracks, related to the volume changes between zones of different moisture content or because of strength developed so far, are avoided.

Conventionally, in order to keep the moisture in the concrete or mortar, a curing process is carried out. Surface methods such as spraying water, fitting impermeable membranes, and moist coverings and/or protecting the surface using impermeable plastic elements are therefore used, along with a handful of others.

An additional method enabled by new technologies is internal curing, wherein the water used to cure the concrete comes from the very mass of the fresh concrete itself. Some of these methods use light porous aggregates, such as expanded clays, expanded perlite or vermiculite, whilst others use diatomaceous earth and the most recent use super-absorbent polymer compounds, capable of absorbing and retaining enough water to serve as a water reserve. Other technologies use materials derived from wood, known as cellulosic materials, which are also able to absorb water and serve as water storage.

All the materials mentioned above are usually added in the final mixture of the concrete or mortar, where cement, additives, aggregates sand and various other additions are mixed together with water in a mixer, in dosages depending on the fresh and final properties of the designed concrete or mortar

Such technologies are know from the prior art. U.S. Pat. No. 5,143,780, dated 1 Sep. 1992, entitled Hydrated fibrous mats for use in curing cement and concrete, describes a method in which cellulose fibres are used to form a material that acts as a barrier to prevent the loss of surface moisture in concrete, thus maintaining the curing process by assuring there is enough water content to produce the hydration reactions in the cement efficiently.

In this patent it is suggested the use of a fibrous material as a surface layer, in contrast to our proposal, wherein the cellulosic material is integrated in the cement, thus avoiding the use of the barriers proposed in the aforementioned patent.

US patent 20070246857, dated 25 Oct. 2007 and entitled Methods for internally curing cement-based materials and products made therefrom describes the use of wood-derived materials as water absorbers for the internal curing of cement-based products. They mention that said materials, which they refer to as cellulosic materials, may be used as fibres or powders in the final mixture of concrete components as a further element, i.e. the cellulosic material is added in the final mixture of the concrete.

By integrating the curing agent in the milling process of the cement components (grinding it together with the clinker, gypsum and remaining additives), any homogeneity problems will be solved in concrete and mortar mixes. This cannot be assured when the curing agents are dosed separately and added in the final concrete mix. Another US patent application, number 20110073015, dated 31 Mar. 2011 and entitled Internally curing cement based materials, mentions that using cellulosic materials makes it possible to cure the cement-based material mixtures internally. It says that it should be bleached cellulosic material, in order to prevent the unwanted effects of the lignin on the performance of the mixtures. It describes the process used to bleach this material and also mentions that these materials are used in the mixture of the materials, i.e. it is used in the final part of the mixing, as a component thereof.

None of the prior art suggests to advantageously process the cellulose fibers together with the clinker during a joint milling operation to produce a cement that contains a homogeneous distribution of internal curing agents (integrated curing agents).

The present invention provides an advantageous novel solution in that the integrated curing agent forms part of the composition of the cement, since it is grounded together with the various normal cement components (clinker, gypsum, other mineral additives). The cement of the invention (for instance Portland based cement containing or not mineral additions like limestone, fly ash, slag, etc.) is composed of a very well distributed shrinkage reducing components or curing agents, which reduces the plastic shrinkage cracking that naturally occurs during the hydration process of the cement in its final application as concrete or mortar. This provides a final concrete or mortar product with an integrated, homogenously distributed curing agent, thus avoiding the storage and management of the reducing or curing admixtures until their final use in the concrete or mortar mix. By grinding simultaneously all the conventional components of the cement and the internal curing agent, a more stable, efficient behaviour is obtained when curing the final concrete mixture.

### BRIEF DESCRIPTION OF THE INVENTION

Concrete is one of the most highly used cement-based mixtures in the construction industry. It has become the main construction material in the world and is used to build infrastructures such as roads and bridges, to cover tunnels and to build homes, buildings and industry. All of these uses require concrete to have different characteristics and designs, and different components are therefore used, which together give us the characteristics required to use the concrete. The components that form concrete are cement, gravel, sand, water and different kinds of additives, which provide concrete with different characteristics.

The theoretical minimum water content with respect to the quantity of cement in a concrete application is 25 weight %. However, excessive water content is usually used to improve the concrete workability and to be properly transported and casted. Water in excess will lead to heterogeneities of the final concrete, segregation of sand and aggregates and bleeding. In order to develop its maximum performance, concrete must be cured to keep moisture long enough in the material to develop compressive strength and durability properties. A process with insufficient curing under extreme temperatures, low moisture and high wind speed conditions for instance, will yield accelerated moisture loss on the concrete surface and cement-based mixtures, leading to the appearance of shrinkage cracks. Such cracks appear during the first few hours (between 1 and 8 hours typically) and may subsequently lead to durability problems and to loss of mechanical performance and finally will be anaesthetic, so architectonic applications will be rejected.

The present invention is a method for producing cement with an integrated curing agent included therein, which comprises: jointly grinding the components of the cement, an integrated curing agent and tensioactive additives; dosing wet the integrated curing agent in order to avoid prior processing thereof and to help to control the temperature of the grinding process and to enable internal curing of the cement-based resulting mixture, which reduces plastic cracking.

In a preferred aspect of the invention, the wet-dosed integrated curing agent is fed in a proportion of 0.05 to 10% of the total weight of the components of the cement, preferably between 1 and 5%.

In a preferred aspect, the wet-dosed integrated curing agent contains cellulose fibres, typically a by-product of the paper recycling process. In still another preferred aspect, the curing agent is made up of 40 to 70% water content and 30 to 60% cellulose solids (wet base). In a more preferred aspect, the wet-dosed integrated curing agent is jointly ground with the components of the cement down to cement production control fineness, usually between 85 and 100% grain size less than 44 microns, to guarantee a homogeneous behaviour, a stable curing process and to prevent larger particles from being segregated.

In another preferred aspect of the method of the invention, the tensioactive additives used to disperse the fibres comprise at least one of the chemicals selected from the group consisting of triisobutyl phosphate, polypropylene glycol, silicone oil products, polydimethylsiloxane and mineral oils. Even more preferably, the dosage of the additives used to disperse the particles of the integrated curing agent is between 0.01 and 1% by weight of the total weight of the components of the cement.

The invention provides a method for producing cement with integrated curing capacity for concrete, mortar or other cement-based mixtures, in such a way that the process is optimised by minimizing the need of external curing, by using an integrated curing agent which is incorporated during the milling process, by grinding it jointly with the cement constituents (clinker, gypsum, mineral additives, fillers, etc.). In other words, the curing agent will form part of the components used to produce the cement, thus differentiating it from the prior art, wherein the absorbent materials are used in the final concrete mixes. The integrated curing agent can consist mainly of by-product from the paper industry recycling process. This by-product may come from the final filtering of paper de-inking process, and as mentioned, contains 30 to 60% solid content. The solid content is mainly composed in average by 50% weight cellulose fibers and 50% weight mineral components (calcium carbonate and/or kaolinite).

The invention provides a novel method to use this by-product material as an integrated curing agent to significantly reduce plastic shrinkage cracking, since the agent acts as an internal source of moisture and to mitigate any accelerated moisture loss in environments where there is a combination of temperature, moisture and wind to produce an evaporation rate of at least 1 kg/m²h.

The invention describes a curing method for concrete elements that ensures an effective hydration process in cement is integrated curing, consisting in the use of a material with water absorption features, suitable to keep moisture in the final concrete throughout the setting and strength e development processes.

In the milling process, internal temperatures often reach up to 150° C., requiring the use of either water or in this case the curing agent with the mentioned moisture content. This moisture will protect the fibers of the curing agent, thus preventing it from being decomposed by the temperature and to lose the desired water absorption properties. This moisture is also important to control the milling conditions (cool down the temperature during the process). If required, additional water injection may be used.

The moisture's percentage is calculated for each batch received as described in the ISO 638:2008, which specifies an oven-drying method to determine the dry matter in paper materials, including pulp/fiber.

If the humidity of the curing agent falls outside the claimed values, the material is simply discarded for its use.

The selection water content of the waste paper pulp from the paper industry is selected between 40% and 70% so the process parameters of the clinker mill are not impacted (rotation, speed, inclination, time, process parameters of the classifiers, etc.) thus not modifying the characteristics of the cement produced (fineness, specific surface, etc.). The selected range also provides manoeuvre so different cements (using different mill process parameters) can be produced from the same paper sludge.

This material is used in the joint milling process of the cement, being fed into the mill at the same time as the clinker, gypsum and other additives allowed by cement quality standards. The dosage of the integrated curing agent (produced in the de-inking process in the paper industry) can be modified depending on the amount of integrated curing agent that the cement needs to reach when it will be used in the concrete mix.

The curing agent is kept in storage before its use, for example, inside bins. The dosage of the integrated curing agent is done by means of conventional weight feeders and transported to the milling step using belt conveyors or any other suitable transport system.

No pre-milling of the material is needed; hence it can be used as received and incorporated into the milling process directly, into any type of mill used in the cement production process (for instance, a ball mill or a vertical mill).

In order to assure the correct dispersion of the cellulose and inorganic content of the curing agent in the cement, tensioactive admixtures are used, which may be selected from the following chemicals: triisobutyl phosphate, polypropylene glycol, silicone oils, mineral oils and siloxanes. The tensioactive admixtures are used in dosages located between 0.01 and 1% by weight of the total weight of the components of the cement depending on the efficacy thereof and compatibility with the cement and the integrated curing agent. These additives are also dosed during the joint milling process (cement production).

As a result of the use of the integrated curing agent, a cement that will provide the concrete and other cement based mixes with self internal curing properties and will reduce plastic shrinkage cracking caused by the accelerated loss of moisture on the surface of the concrete or mortars. The components of the integrated curing agent act as moisture reserves, which help in the cement hydration process and prevent the surface of the concrete from drying prematurely.

The variable used to find out whether the integrated curing process is efficient is the reduction in the plastic shrinkage cracking produced by the accelerated loss of moisture on the surface of the concrete elements or of cement-based mixes. It is measured as a percentage of the reduction of the cracked area in comparison tests and the method for taking these measurements is described in the technical document of the ACI materials journal, No. 97-M50, by means of which extreme environmental conditions are simulated. In these extreme simulated conditions, a moisture evaporation rate of over 1 kg/m²h is maintained.

Using this method for different size of slabs, it could be demonstrated that concretes produced using the cement containing the integrated curing agent achieve up to 100% less plastic shrinkage cracking compared to those concretes prepared using conventional types of cement (which do not contain an integrated curing agent).

The tests shown in the following Examples 1-5 show that plastic cracking or fissures are indeed reduced, and further show that using dosages of over 10% of integrated curing agent significantly increases the percentage of air included in the concrete, which affects performance (compressive strength) of the final concrete mixes using the cement according to the invention. In range of 1 to 5% of integrated curing agent it does not produce significant changes in performance regarding reduction of cracking.

It is important to emphasise that the integrated curing agent is incorporated into cement during the joint milling of the components that compose the cement (clinker, gypsum, other additions, fillers, etc.), thus obtaining a much more effective way to homogenize than the one obtained using traditional methods where all the components are added to the final concrete mix. Using the right dosage of material for joint milling it is possible to obtain a product capable of facilitating the curing process, since the curing agent acts as an internal water storage providing the concrete or mortar surface moisture that is lost when the surface in contact with the environmental conditions

It must be noted that the portion of cellulose and the inorganic load contained in the by-product coming from the paper industry together with the cement materials, is reduced in size to a maximum particle size of 45 microns (confirmed by a particle-size distribution analysis), and homogeneously distributed throughout the entire concrete or mortar mass once the cement according to the invention is used to produce final products. This homogeneity enables the cellulose fibres milled and reduced in size to act in a more effective way as a water reserve compared to the un processed fibres added directly in the final mixing of concrete or mortars components.

The main advantage of the cement according to the invention is to provide cement in bags that already contains internal curing additives (cellulose fibers). Users will not need to buy special curing agents to be added in the final mixing with water and and/or aggregates.

One additional advantage of producing cement using an integrated curing agent with self-curing properties, which reduces plastic shrinkage cracking up to 100%, is that it also eliminates the need for additional equipment in concrete plants, since no silo, dosing system or other equipment is required for handling curing materials added during preparation of concrete.

The cement with an integrated curing agent included therein is compatible with the additives commonly used to prepare concrete, such as water reducers, plasticisers, accelerants and retardants, etc. That are added during the final mixing with water and sand or a/and aggregates. It is also compatible with other additives, that can be used in the cement during the milling of the clinker (water repellent agents, water reducing agents, plasticizers, etc.)

### FIGURES

FIG. 1: Image of the slabs after 4 hours of exposition to environmental conditions. The upper portion shows the cement with the integrated curing agent in a high moisture aspect, whilst the lower portion, shows the reference cement, with an evident cement that has retained less water over 6 hours exposure to the wind tunnel.

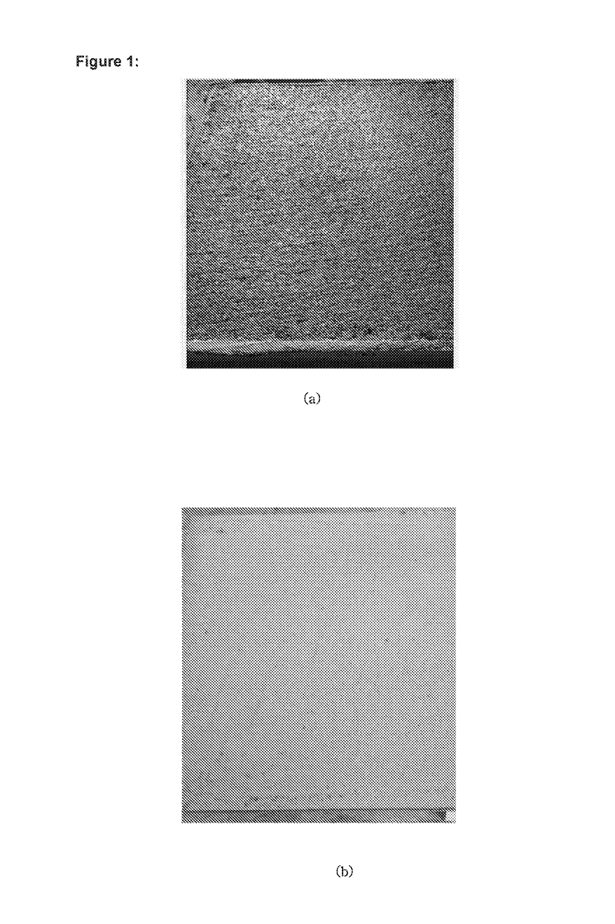

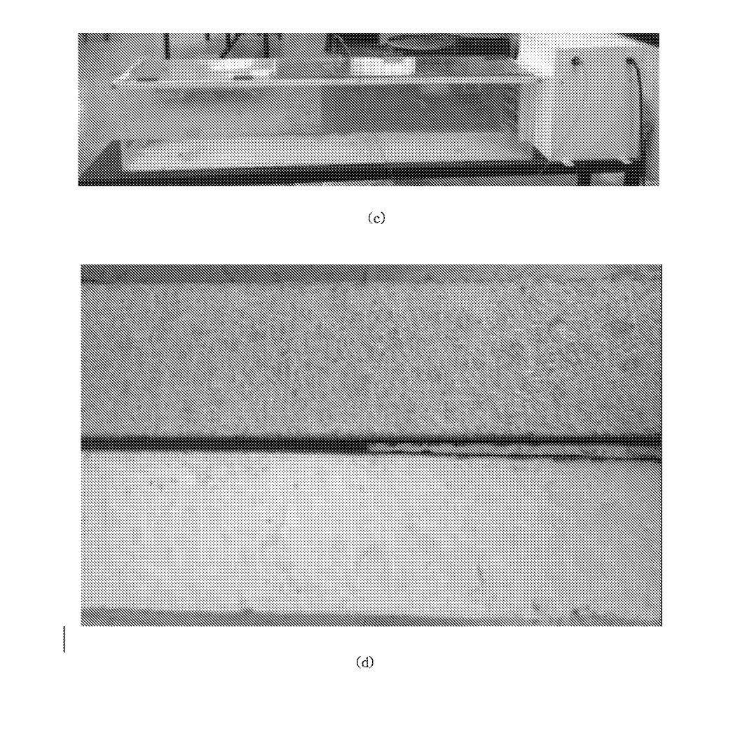

(a) Cement with integrated curing agent,
(b) Cement without integrated curing agent, presenting multiple cracks.
(c) Wind tunnel used in the laboratory tests for simulated drying conditions,
(d) View of a pair of concrete bars exposed to the wind tunnel.

### EXAMPLES

The following examples are tests carried out to determine the reduction in plastic shrinkage cracking in casted concrete elements, provided for the purpose of showing the present invention in an illustrative yet non-limiting manner.

### Example 1

Wind tunnel tests according to as in the method described in the technical document of the ACI is used, and wherein a comparison is made between a cement without an integrated curing agent, named CPC 30R, under the Mexican standard NMX C-414 ONNCCE, using aggregates from Mexico City (gravel and sand). The conditions of the tunnel simulating extreme environmental conditions are indicated in table 1. These conditions simulate extreme environmental conditions giving as a results an evaporation rate of 1.9 kg/m²h, under these conditions, the reduction in plastic shrinkage cracking in the concrete element containing the integrated curing agent is 64%, reducing from 77 mm² the cracked area to 22.5 mm².

TABLE 1
Table 1: Tests results for example 1.
The cement used in example 1 is composed as follows:
Integrated curing agent - 1.0% by weight.
Dispersion agent (polypropylene glycol) - 0.07% by weight.
Cement fineness - 96% less than 44 microns.
Moisture of the integrated curing agent used to produce the cement - 60%.

| | | | CPC 30 R |
|---|---|---|---|
| | | | cement with |
| | | CPC 30R | integrated |
| | | Reference | curing agent |
| Cement consumption | kg/m³ | 300 | |
| Gravel:sand ratio | | 1.5 | |
| Reduction in size | cm | 18 ± 1 | |
| Origin aggregates | | Mexico City | |
| Bar size | cm | 110 × 5 × 10 | |
| Temperature at tunnel entrance | ° C. | 49 | |
| Temperature at tunnel exit | ° C. | 47 | |
| Evaporation rate | kg/h*m² | 1.9 | |
| Wind speed | km/h | 5.6 | |
| Cracked area | mm² | 71.1 | 25.5 |
| Reduction in plastic cracking | % | — | 64 |

### Example 2

Wind tunnel tests according to as in the method described in the technical document of the ACI is used, and wherein a comparison is made between a cement without an integrated curing agent, named CPC 30R, under the Mexican standard NMX C-414 ONNCCE, using aggregates from Mexico City (gravel and sand). The conditions of the tunnel simulating extreme environmental conditions are indicated in table 2. These conditions simulate extreme environmental conditions giving as a results an evaporation rate of 2.0 kg/m²h, under these conditions, the reduction in plastic shrinkage cracking in the concrete element containing the integrated curing agent is 71.7%, reducing from 125 mm² of cracked area to 35.4 mm². The concrete elements are produced with a dosage of 300 kg of cement in both cases, with enough water content to obtain a reduction in size of 18 cm.

TABLE 2
Table 2: Test results for example 2
The cement used in example 2 is composed as follows:
Integrated curing agent - 7.5% by weight.
Dispersion agent (TIBP) - 0.01% by weight.
Cement Fineness - 97% less than 44 microns.
Moisture of the integrated curing agent used to produce the cement - 60%.

| | | | CPC 30 R |
|---|---|---|---|
| | | | cement with |
| | | CPC 30R | integrated |
| | | Reference | curing agent |
| Cement consumption | kg/m³ | 300 | |
| Gravel:sand ratio | | 1.5 | |
| Reduction in size | cm | 18 ± 1 | |
| Origin aggregates | | Mexico | |
| Bar size | cm | 110 × 10 × 5 | |
| Temperature at tunnel entrance | ° C. | 52 | |
| Temperature at tunnel exit | ° C. | 45 | |
| Evaporation rate | kg/h*m² | 2.0 | |
| Wind speed | km/h | 6.9 | |
| Cracked area | mm² | 125.2 | 35.4 |
| Reduction in plastic cracking | % | — | 71.7 |

### Example 3

Wind tunnel tests according to as in the method described in the technical document of the ACI is used, and wherein a comparison is made between a cement without an integrated curing agent, named CPC 30R, under the Mexican standard NMX C-414 ONNCCE, using aggregates from Monterrey (gravel and sand). The conditions of the tunnel simulating extreme environmental conditions are indicated in table 3. The environmental conditions are indicated in the table 3. Under these conditions, the result obtained in plastic shrinkage cracking reduction in the casted element containing cement with the integrated curing agent, is 100%, going from 369 mm² of cracked area to 0 mm². The concrete slabs were made using a dosage of 250 kg of cement in both cases, with enough water content to obtain a reduction in size of 18 cm.

TABLE 3
Table 3: Test results of example 3
The cement used in example 3 is composed as follows:
Integrated curing agent - 5.0% by weight.
Dispersion agent (mineral oil) - 0.050% by weight.
Cement fineness - 97% less than 44 microns.
Moisture of the integrated curing agent used to produce the cement - 60%.

| | | | CPC 30 R |
|---|---|---|---|
| | | | cement with |
| | | CPC 30R | integrated |
| | | Reference | curing agent |
| Cement consumption | kg/m³ | 250 | |
| Gravel:sand ratio | | 1.0 | |
| Reduction in size | Cm | 18 ± 1 | |
| Origin aggregates | | Monterrey | |
| Bar size | Cm | 100 × 100 × 9 | |
| Ambient temperature | ° C. | 29 | |
| Wind speed | km/h | 10 | |
| Cracked area | mm² | 369 | 0 |
| Reduction in plastic cracking | % | — | 100 |

### Example 4

Wind tunnel tests according to as in the method described in the technical document of the ACI is used, and wherein a comparison is made between a cement without an integrated curing agent, named CPC 30R, under the Mexican standard NMX C-414 ONNCCE, using aggregates from Mexico City (gravel and sand). The conditions of the tunnel simulating extreme environmental conditions are indicated in table 4. These conditions simulate extreme environmental conditions giving as a results an evaporation rate of 1.9 kg/m²h, under these conditions, the reduction in plastic shrinkage cracking in the concrete element containing the integrated curing agent is 82%, reducing from 108.2 mm² the cracked area to 19.4 mm2.

TABLE 4
Table 4: Tests results for example 4.
The cement used in example 4 is composed as follows:
Integrated curing agent - 2.5% by weight.
Dispersion agent (polypropylene glycol) - 0.06% by weight.
Cement fineness - 96% less than 44 microns.
Moisture of the integrated curing agent used to produce the cement - 50%.

| | | | CPC 30 R |
|---|---|---|---|
| | | | cement with |
| | | CPC 30R | integrated |
| | | Reference | curing agent |
| Cement consumption | kg/m³ | 300 | |
| Gravel:sand ratio | | 1.5 | |
| Reduction in size | cm | 18 ± 1 | |
| Origin aggregates | | Mexico City | |
| Bar size | cm | 110 × 5 × 10 | |
| Temperature at tunnel entrance | ° C. | 49 | |
| Temperature at tunnel exit | ° C. | 47 | |
| Evaporation rate | kg/h*m² | 1.9 | |
| Wind speed | km/h | 5.6 | |
| Cracked area | mm² | 108.2 | 19.4 |
| Reduction in plastic cracking | % | — | 82 |

### Example 5

Wind tunnel tests according to as in the method described in the technical document of the ACI is used, and wherein a comparison is made between a cement without an integrated curing agent, named CPC 30R, under the Mexican standard NMX C-414 ONNCCE, using aggregates from Monterrey (gravel and sand). The conditions of the tunnel simulating extreme environmental conditions are indicated in table 5. The environmental conditions are indicated in the table 5. Under these conditions, the result obtained in plastic shrinkage cracking reduction in the casted element containing cement with the integrated curing agent, is 59%, going from 285.2 mm² of cracked area to 116.8 mm². The concrete slabs were made using a dosage of 250 kg of cement in both cases, with enough water content to obtain a reduction in size of 18 cm.

TABLE 5
Table 5: Test results of example 5
The cement used in example 5 is composed as follows:
Integrated curing agent - 2.0% by weight.
Dispersion agent (mineral oil) - 0.030% by weight.
Cement fineness - 97% less than 44 microns.
Moisture of the integrated curing agent used to produce the cement - 70%.

| | | | CPC 30 R |
|---|---|---|---|
| | | | cement with |
| | | CPC 30R | integrated |
| | | Reference | curing agent |
| Cement consumption | kg/m³ | 250 | |
| Gravel:sand ratio | | 1.0 | |
| Reduction in size | Cm | 18 ± 1 | |
| Origin aggregates | | Monterrey | |
| Bar size | Cm | 100 × 100 × 9 | |
| Ambient temperature | ° C. | 29 | |
| Wind speed | km/h | 10 | |
| Cracked area | mm² | 285.2 | 116.8 |
| Reduction in plastic cracking | % | — | 59 |

1. A method for producing a cement with an integrated curing agent, which comprises the following steps:
a. jointly grinding the components of a cement, an integrated curing agent and tensioactive additives;
b. dosing wet the curing agent;
c. internally curing the cement-based resulting mixture.

2. The method according to claim 1, wherein said wet-dosed integrated curing agent is fed in a proportion of 0.05 to 10% of the total weight of the components of the cement.

3. The method according to claim 1, wherein said wet-dosed integrated curing agent contains cellulose fibres.

4. The method according to claim 2, wherein said wet-dosed integrated curing agent contains 40 to 70% water and 30 to 60% solid content, both percentages by weight.

5. The method according to claim 2, wherein said wet-dosed integrated curing agent is jointly ground with the components of the cement down to cement production control fineness, between 85 and 100% grain size less than 44 microns.

6. The method according to claim 1, wherein said tensioactive additives comprise at least one of the chemicals selected from the group consisting of triisobutyl phosphate, polypropylene glycol, silicone oil products and polydimethylsiloxane and mineral oils.

7. The method according to claim 1, wherein the dosage of said tensioactive additives are between 0.01 and 1% by weight of the total weight of the components of the cement.

8. The method according to claim 2, wherein said wet-dosed integrated curing agent is fed in a proportion of between 1 and 5% of the total weight of the components of the cement.
